(19) United States
(12) Patent Application Publication
(10) Pub. No.: US 2012/0087489 A1
(43) Pub. Date: Apr. 12, 2012

(54) CRYPTOGRAPHIC PROCESSING APPARATUS AND CONTROL METHOD FOR CRYPTOGRAPHIC PROCESSING CIRCUIT

(75) Inventors: Yasuteru SEKIYA, Kanagawa (JP); Tooru HISAKADO, Kanagawa (JP)

(73) Assignee: RENESAS ELECTRONICS CORPORATION, Kawasaki-shi (JP)

(21) Appl. No.: 13/253,479

(22) Filed: Oct. 5, 2011

(30) Foreign Application Priority Data
Oct. 12, 2010 (JP) 2010-229522

(51) Int. Cl. H04L 9/28

(52) U.S. Cl. 380/28

(57) ABSTRACT

An aspect of the present invention is a cryptographic processing apparatus including a division unit that divides input data into multiple partial data items, the input data being one of plaintext and a round processing result; multiple data holding units that hold the partial data items, respectively; and a combining unit that combines the partial data items held in the multiple data holding units into a single round processing target data item to be subjected to round processing. The division unit selects a storage destination of each partial data item from among the data holding units, and stores each of the partial data items into the storage destination selected. The combining unit combines the partial data items into a round processing target item to reconstruct the input data according to the storage destination of each partial data item selected by the division unit.

### CROSS-REFERENCE TO RELATED APPLICATIONS

This application is based upon and claims the benefit of priority from Japanese patent application No. 2010-229522, filed on Oct. 12, 2010, the disclosure of which is incorporated herein in its entirety by reference.

### BACKGROUND

The present invention relates to a cryptographic processing apparatus and a control method for a cryptographic processing circuit, and more particularly, to a cryptographic processing apparatus and a control method for a cryptographic processing circuit, in which cryptographic processing using symmetric-key cryptography is implemented as hardware.

Along with the increasing demand for security, there is a growing need for systems capable of performing cryptographic processing on large volumes of data at high speed. Symmetric-key cryptography techniques such as Triple Data Encryption Standard (TDES) and Advanced Encryption Standard (AES) are used to encrypt and decrypt large volumes of data. A higher processing speed is achieved by hardware implementation.

On the other hand, systems having such a symmetric-key cryptography function have faced a growing threat from Differential Power Analysis (DPA) which is one example of side-channel attack. (See Paul Kocher, Joshua Jaffe, and Benjamin Jun, “Introduction to Differential Power Analysis and Related Attacks”, 1998.)

Side-channel attack is an attack technique to estimate a cipher secret key by utilizing side-channel information such as power consumption during execution of processing in an apparatus having a cryptographic processing function, electromagnetic wave, and processing time.

The DPA uses multiple pieces of information on electric power consumed during cryptographic processing using a common secret key and different input/output data. The power consumption slightly varies depending on intermediate data determined by the input/output data and the secret key. An attacker estimates a part of the secret key and predicts a change in multiple pieces of power consumption information based on the intermediate data and input/output data obtained by the estimation. Multiple pieces of power consumption information are classified into two groups according to the magnitude of the predicted change in power consumption. Further, noise is eliminated by averaging and a difference between the groups is then extracted. Only when the estimated key is correct, the classification into groups can be properly made and a difference is generated. Accordingly, the estimated key with which a difference between the groups can be confirmed is estimated as a correct key.

Although the above explanation has been made assuming that electric power is used as side-channel information, a similar attack may be made through electromagnetic waves, for example (see K. Gandolfi, C. Mourtel, and F. Olivier, “Electromagnetic Analysis: Concrete Results”, CHES 2001, LNCS 2162, pp. 251-261, 2001).

FIG. 4 is a block diagram showing a configuration of a cryptographic processing circuit 400 according to the related art. Herein, a description will be given of a case where the cryptographic processing circuit 400 performs cryptographic processing using plaintext as input data 21 and ciphertext as output data 23. However, decryption processing using ciphertext as the input data 21 and plaintext as the output data 23 can also be performed in a similar manner. The cryptographic processing circuit 400 includes a selector 410, a register 420, a round processing unit 430, a register 440, and a round key generating unit 450. The selector 410 selects the input data 21 (plaintext) at the start of the cryptographic processing, and selects a round processing result of the round processing unit 430 during the cryptographic processing. The register 420 stores the results selected by the selector 410. The round processing unit 430 performs round processing on the data stored in the register 420. The register 440 stores ciphertext when the cryptographic processing is finished, and outputs the output data 23 (ciphertext). The round key generating unit 450 outputs results of generating each round key based on a secret key 22 to the round processing unit 430.

The cryptographic processing circuit 400 shown in FIG. 4 receives the input data 21 as plaintext and the secret key 22 as a secret key. Further, the cryptographic processing unit 400 executes round processing multiple times to thereby perform cryptographic processing, and outputs the output data 23 as ciphertext.

FIG. 5 is a timing diagram for explaining the operation of the cryptographic processing circuit 400 illustrated in FIG. 4. Symbols shown in the timing diagram of FIG. 5 are defined as follows.
[CLK]: a clock signal
[Key]: a secret key
[D_in]: input data (plaintext)
[Ki]: a round key generated in the round key generating unit 450
[Start]: a cryptographic processing start signal
[Reg]: data stored in the register 420
[F_in]: received data of the round processing unit 430
[F_out]: output data of the round processing unit 430
[End]: a cryptographic processing end signal
[Reg_o]: output data (ciphertext)

First, the cryptographic processing start signal Start becomes high level. In response to this, the selector 410 selects input data DO and stores the input data DO in the register 420 at a rising edge of the clock signal CLK.

Upon receiving the input data DO and the round key K1 generated in the round key generating unit 450, the round processing unit 430 performs a first round processing (i=1) and outputs output data D1. At this time, the cryptographic processing start signal Start is at a low level. Accordingly, the selector 410 selects the output data D1 from the round processing unit 430 and stores the output data D1 at a rising edge of the clock signal CLK.

When the round processing is repeated by a prescribed number of times (n times), the cryptographic processing end signal End becomes high level. In response to this, the round processing unit 430 stores output data Dn in the register 440 at a rising edge of the clock signal CLK. After that, the output data Dn stored in the register 440 is output as ciphertext.

In the cryptographic processing circuit 400 having the configuration described above, a Hamming distance obtained when data changes is the main cause of the generation and change of power consumption.

In the cryptographic processing shown in FIG. 4, an attacker carries out a DPA attack in the following manner, for example. First, the attacker estimates the round key Ki, and further estimates, from the observable input data DO or output data Dn, a Hamming weight and data transition in the register 420 storing the data used in the round processing or round processing results, thereby estimating a change in power consumption.

As a countermeasure against the DPA attack, it is necessary to prevent the attacker from estimating the Hamming weight of the internal data and data transition.

Japanese Unexamined Patent Application Publication No. 2007-195132 proposes a method as a countermeasure against the DPA attack. FIG. 6 is a block diagram showing a configuration of a cryptographic processing circuit 300 disclosed in Japanese Unexamined Patent Application Publication No. 2007-195132. The cryptographic processing circuit 300 is a semiconductor integrated circuit that executes an encryption algorithm including a plurality of round repeating processings. The cryptographic processing circuit 300 includes an initial permutation unit 301, switches SW1p and SW1q, DES operation circuits 310 and 320, an inverse permutation unit 302, a secret key 351, a dummy key 352, a switch SW3, a first key schedule unit 353, a dummy key 361, a second key schedule unit 362, and switches SW2p and SW2q.

The DES operation circuit 310 includes a register 311, a register 312, and an F-function unit 313. The DES operation circuit 320 includes a register 321, a register 322, and an F-function unit 323. The DES operation circuits 310 and 320 are two round processing units that execute the F-function units 313 and 323, respectively.

The first key schedule unit 353 outputs a regular round key for regular round processing to each of the DES operation circuits 310 and 320. The second key schedule unit 362 outputs a dummy round key for dummy round processing to each of the DES operation circuits 310 and 320.

The DES operation circuits 310 and 320 repeatedly execute the regular round processing, to which the regular round key is applied, and the dummy round processing, to which the dummy round key is applied, in an alternating manner. At this time, the F-function unit 313 performs the round processing using data stored in the register 312 and key data output from the switch SW2p. The register 322 stores the sum of data stored in the register 3 and a processing result of the F-function unit 313. The register 321 stores the data stored in the register 312. The F-function unit 323 performs round processing using the data stored in the register 322 and key data output from the switch SW2q. After that, the register 311 stores the data stored in the register 322. The register 312 stores the sum of data stored in the register 321 and a processing result of the F-function unit 323.

That is, a regular round processing result and a dummy round processing result are alternately stored in the registers 311 and 312 and the registers 321 and 322. Accordingly, even when bit changes at the time when data is updated in each register are obtained by current measurement, all the bit changes are based on the dummy round processing result to which the dummy round keys is applied, i.e., based on unknown values generated by dummy processing. This results in achieving a cryptographic processing apparatus that can deal with the DPA attack using statistical processing of consumption current.

### SUMMARY

However, the present inventors have found a problem that the countermeasure against a DPA attack as disclosed in Japanese Unexamined Patent Application Publication No. 2007-195132 requires another pair of the round processing unit 430 and the round key generating unit 450, as compared to the cryptographic processing circuit 400 shown in FIG. 4. Accordingly, the circuit size is more than twice that of the typical cryptographic processing circuit 400. This causes a problem of an increase in circuit size, i.e., an increase in cost of countermeasures. In other words, in Japanese Unexamined Patent Application Publication No. 2007-195132, it is difficult to suppress an increase in circuit size, while taking countermeasures against an attack based on a differential power analysis or an analysis of electromagnetic waves or the like using side-channel information.

A first aspect of the present invention is a cryptographic processing apparatus including: a division unit that divides input data into a plurality of partial data items, the input data being one of plaintext and a round processing result; a plurality of data holding units that hold the partial data items, respectively; and a combining unit that combines the partial data items held in the plurality of data holding units into a single round processing target data item to be subjected to round processing. The division unit selects a storage destination of each of the partial data items from among the plurality of data holding units, and stores each of the partial data items into the storage destination selected. The combining unit combines the partial data items into the round processing target item to reconstruct the input data according to the storage destination of each partial data item selected by the division unit.

A second aspect of the present invention is a control method for a cryptographic processing circuit including a plurality of data holding units, the control method including: dividing input data into a plurality of partial data items, the input data being one of plaintext and a round processing result; selecting a storage destination of each of the partial data items from among the plurality of data holding units; storing each of the partial data items into the storage destination selected; and combining the partial data items held in the plurality of data holding units into a single round processing target data item to reconstruct the input data according to the storage destination of each partial data item selected.

According to the first and second aspects of the present invention, the plaintext or round processing target data is divided, and the data holding units for storing the divided data are changed every time the divided data is to be stored. This configuration makes it difficult for an attacker, who carries out an analysis using side-channel information, to estimate data transition in each register. Furthermore, the configuration for performing cryptographic processing and key generation processing is the same as that of the typical cryptographic processing circuit 400 shown in FIG. 4. Therefore, it is possible to take countermeasures against an attack using side-channel information, while suppressing an increase in circuit size as compared to Japanese Unexamined Patent Application Publication No. 2007-195132.

According to an aspect of the present invention, it is possible to provide a cryptographic processing apparatus and a control method for a cryptographic processing circuit which are capable of taking countermeasures against an attack based on a differential power analysis or an analysis of electromagnetic waves or the like using side-channel information, while suppressing an increase in circuit size.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a cryptographic processing circuit according to a first embodiment of the present invention;

FIG. 2 is a timing diagram showing cryptographic processing according to the first embodiment of the present invention;

FIG. 3 is a block diagram showing a configuration of a cryptographic processing circuit according to a second embodiment of the present invention;

FIG. 4 is a block diagram showing a configuration of a cryptographic processing circuit according to a related art;

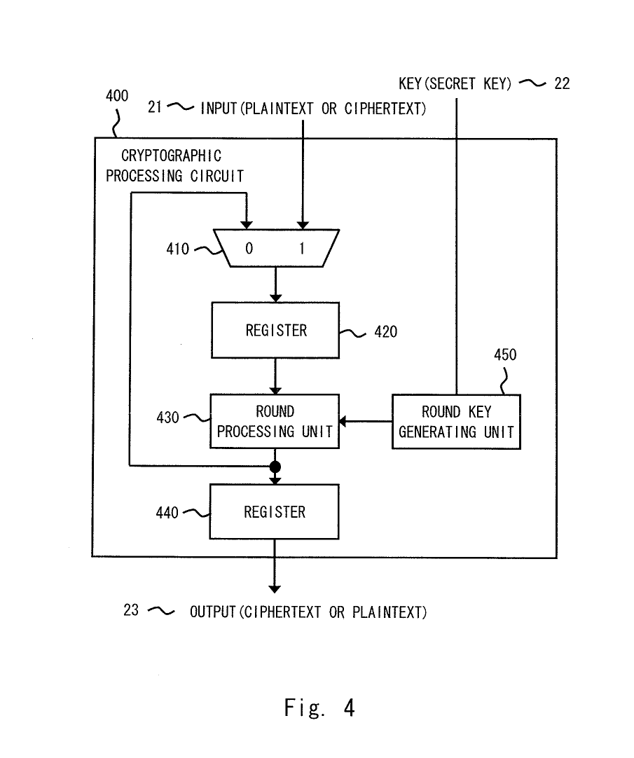

FIG. 5 is a timing diagram showing cryptographic processing according to the related art; and

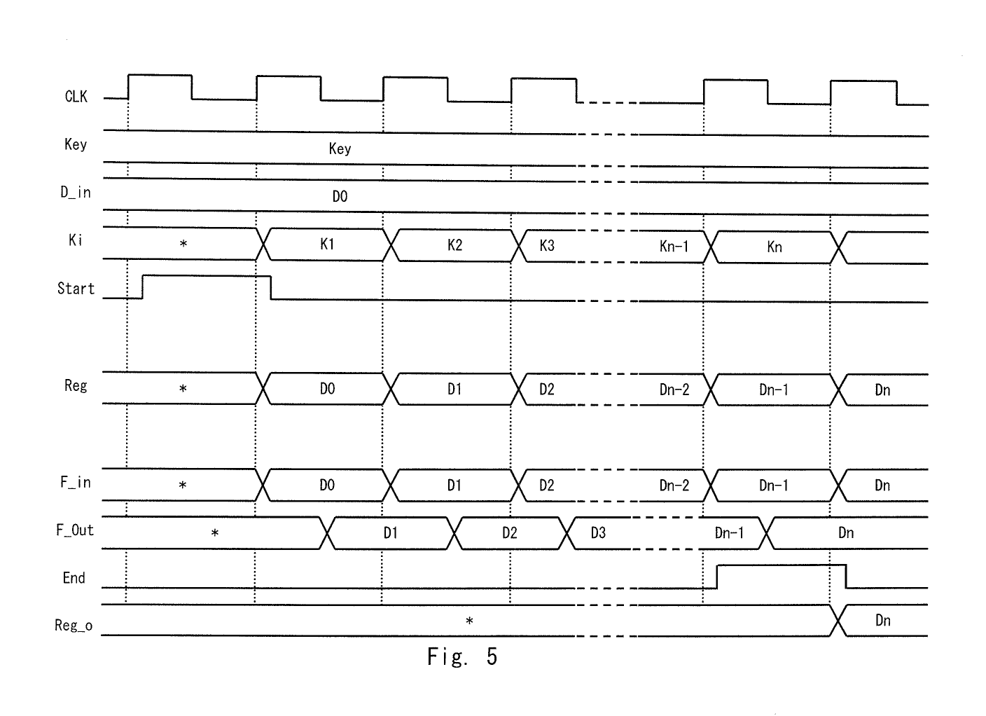

FIG. 6 is a block diagram showing a configuration of a cryptographic processing circuit according to a related art.

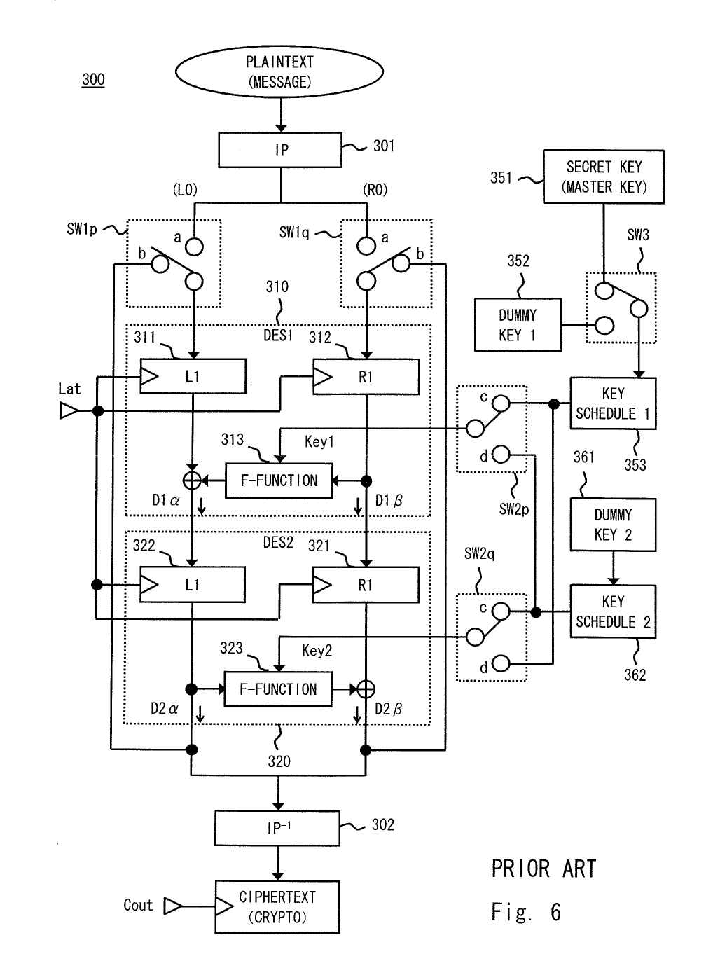

### DETAILED DESCRIPTION

Hereinafter, embodiments of the present invention will be described in detail with reference to the drawings. Throughout the drawings, the same components are denoted by the same reference numerals, and a repeated explanation is omitted as needed to clarify the explanation.

### First Embodiment

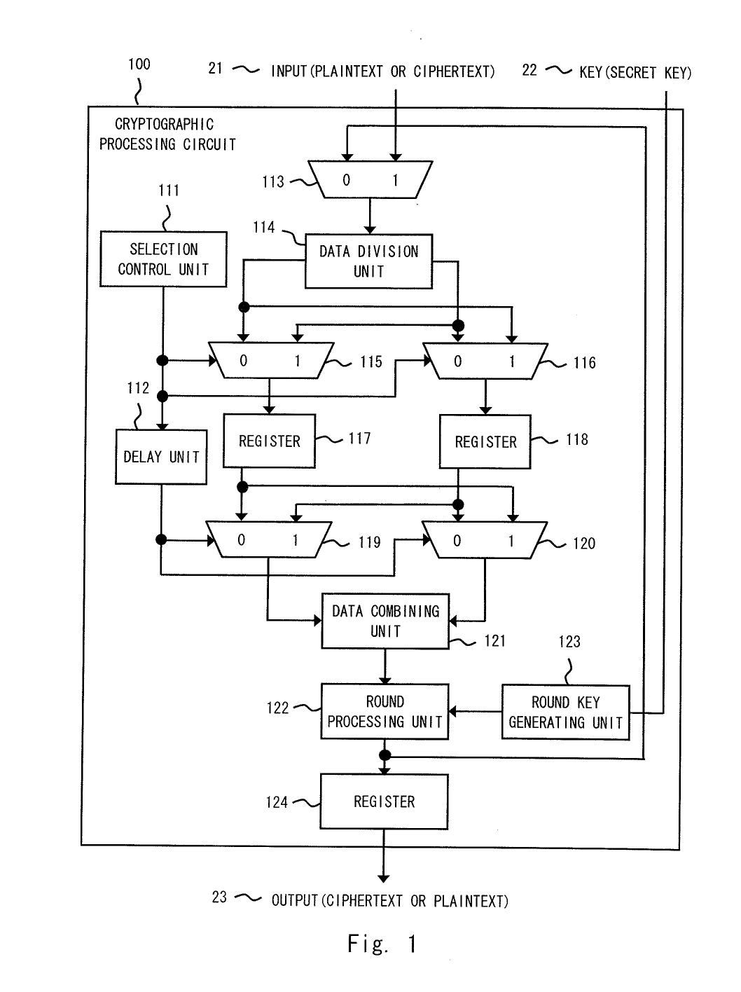

FIG. 1 is a block diagram showing a configuration of a cryptographic processing circuit 100 according to a first embodiment of the present invention. The cryptographic processing circuit 100 includes a selection control unit 111, a delay unit 112, a selector 113, a data division unit 114, selectors 115 and 116, registers 117 and 118, selectors 119 and 120, a data combining unit 121, a round processing unit 122, a round key generating unit 123, and a register 124.

The cryptographic processing circuit 100 is a semiconductor integrated circuit that receives input data 21 and a secret key 22, encrypts the data by performing round processing multiple times, and outputs output data 23. When the input data 21 is plaintext, the output data 23 is ciphertext. When the input data 21 is ciphertext, the output data 23 is plaintext.

The selection control unit 111 generates a selection control signal for the selectors 115 and 116 and the selectors 119 and 120, and outputs the generated selection control signal to each of the selectors 115 and 116 and the selectors 119 and 120. That is, the selection control unit 111 outputs the selection control signal for selecting a storage destination in accordance with a predetermined standard. Specifically, the selection control signal is a signal for selecting one of input terminals “0” and “1” of the selectors 115 and 116 and the selectors 119 and 120. The term “predetermined standard” herein described refers to a standard for replacing the storage destination to be selected according to a clock signal, or a standard for randomly designating the storage destination to be selected, for example.

The delay unit 112 delays the selection control signal output by the selection control unit 111, and outputs the delayed selection control signal to each of the selectors 119 and 120.

Upon receiving the input data 21 and the output of the round processing unit 122, the selector 113 selects the input data 21 at the start of the cryptographic processing, and selects the round processing result, which is the output of the round processing unit 122, during the cryptographic processing. Then, the selector 113 outputs the selected data to the data division unit 114.

The data division unit 114 divides the input data from the selector 113, and outputs the divided data to each of the selectors 115 and 116. Specifically, the data division unit 114 receives the plaintext or the round processing result, which is selected by the selector 113 in the cryptographic processing, as the input data for the data division unit 114, and divides the input data into a plurality of partial data items.

The data division unit 114 may divide the input data by any method. For example, the data division unit 114 may divide the input data into upper bits and lower bits. More alternatively, the data division unit 114 may divide the input data into odd-numbered bits and even-numbered bits, or into randomly selected bits. Any method can be employed as long as each bit of the input data is contained in any one of the partial data items, i.e., as long as the division method of the data division unit 114 corresponds to the combining method of the data combining unit 121.

The selector 115 selects one of the partial data items, which are obtained through division of the input data by the data division unit 114, according to the selection control signal generated by the selection control unit 111, and outputs the selected partial data item to the register 117. The selector 116 selects one of the partial data items, which are not selected by the selector 115, according to the selection control signal generated by the selection control unit 111, and outputs the selected partial data item to the register 118. In this case, the selectors 115 and 116 select an input of one of the input terminals “0” and “1” according to the selection control signal, and output the selected input to each register. For example, assume that the data input to the data division unit 114 is 8-bit data and the data division unit 114 employs a method for dividing the input data into upper bits and lower bits. In this case, the data division unit 114 outputs upper four bits to each of the input terminal “0” of the selector 115 and the input terminal “1” of the selector 116, and outputs lower four bits to each of the input terminal “1” of the selector 115 and the input terminal “0” of the selector 116. Assume therein that the selection control signal generated by the selection control unit 111 indicates selection of the input terminal “1”. In this case, the selector 115 selects the lower four bits received from the input terminal “1” and stores the selected bits into the register 117. The selector 116 selects the upper four bits received from the input terminal “1” and stores the selected bits into the register 118.

In other words, the selectors 115 and 116 select the storage destination of each of the partial data items from among a plurality of data holding units, and store each of the partial data items into the selected storage destination. The selectors 115 and 116 select the storage destination from the plurality of data holding units based on the selection control signal.

The registers 117 and 118 store output results of the selectors 115 and 116, and output the stored data to the selectors 119 and 120. In other words, the registers 117 and 118 are data holding units for respectively holding the partial data items.

The selector 119 selects one of the outputs of the registers 117 and 118 according to the selection control signal generated by the selection control unit 111, and outputs the data stored in the selected register to the data combining unit 121. The selector 120 selects the register, which is not selected by the selector 119, according to the selection control signal generated by the selection control unit 111, and outputs the data stored in the selected register to the data combining unit 121. In this case, the input terminal “0” of the selector 119 is connected to the output of the register 117, and the input terminal “1” of the selector 119 is connected to the output of the register 118. The input terminal “0” of the selector 120 is connected to the output of the register 118, and the input terminal “1” of the selector 120 is connected to the output of the register 117.

In the above-mentioned example, i.e., in the case where the selection control signal indicates selection of the input terminal “1”, the selector 119 selects the data received from the input terminal “1”, i.e., the upper four bits stored in the register 118, and outputs the selected data to the data combining unit 121. The selector 120 selects the data received from the input terminal “1”, i.e., the lower four bits stored in the register 117, and outputs the selected data to the data combining unit 121.

The data combining unit 121 combines the inputs of the selectors 119 and 120, and outputs the combined inputs to the round processing unit 122. That is, the data combining unit 121 combines the partial data items held in the plurality of data holding units into a single cryptographic processing target data item to be subjected to cryptographic processing.

For example, when the data input to the data division unit 114 is 8-bit data and the data division unit 114 employs a method for dividing the input data into upper bits and lower bits, the data combining unit 121 combines the data received from the selector 119 as the upper bits with the data received from the selector 120 as the lower bits. Specifically, in this case, the data combining unit 121 combines the partial data items to obtain the cryptographic processing target data item so as to reconstruct the data input to the data division unit 114 according to the storage destination of each partial data item selected by the data division unit 114.

The round key generating unit 123 receives the secret key 22 to generate a round key Ki, and outputs the generated round key to the round processing unit 122.

The round processing unit 122 performs round processing on the output result from the data combining unit 121, and outputs the processing result to each of the selector 113 and the register 124. Herein, the round processing is processing including permutation and transposition, logical operation, and arithmetic operation. Many common key cryptosystems achieve a sufficient cipher strength by scrambling the input data by round processing in a plurality of rounds.

The register 124 stores the output result from the round processing unit 122. The register 124 outputs the output data 23 as the cryptographic processing result upon completion of the cryptographic processing.

The selection control unit 111 preferably outputs the selection control signal every time the input data is input to the data division unit 114. Alternatively, the selection control unit 111 may output the selection control signal every time the round processing is carried out by the round processing unit 122. As a result, the storage destination is switched every time the partial data is stored in the registers 117 and 118. This makes it difficult for an attacker to estimate data transition in each register, and makes it possible to more effectively take countermeasures against a DPA attack and the like.

Furthermore, in the first embodiment of the present invention, the data division unit 114 uses the cryptographic processing result for the cryptographic processing target data in the round processing unit 122 as the input data. The selection control unit 111 outputs the selection control signal along with recursive execution of the cryptographic processing. This makes it possible to take countermeasures against a DPA attack and the like while suppressing an increase in circuit size.

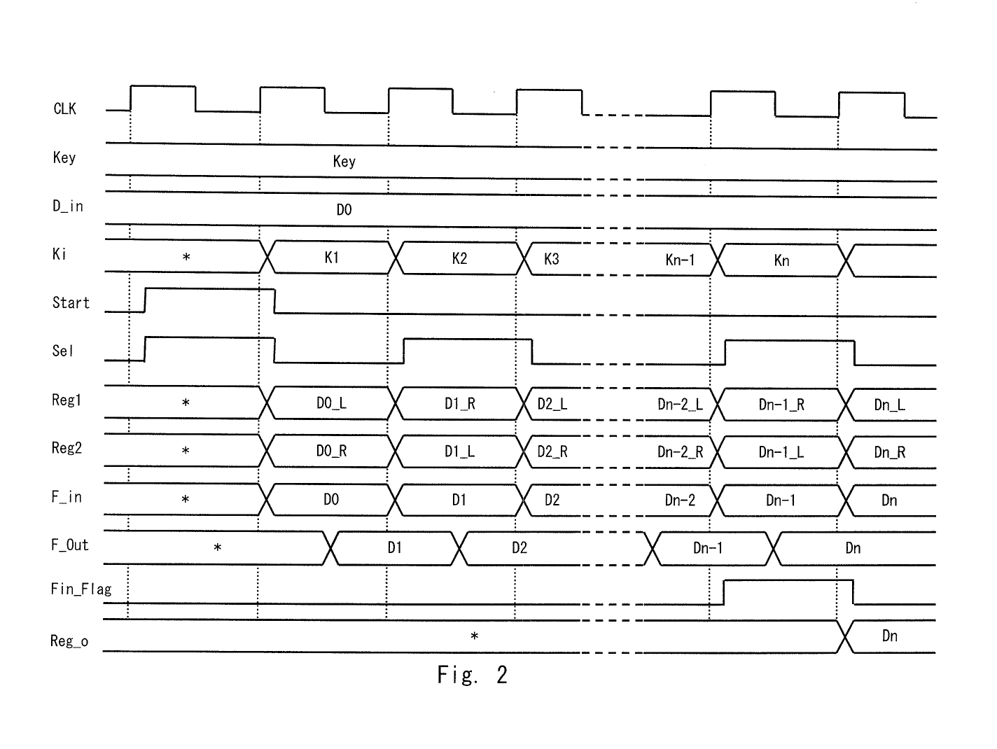

FIG. 2 is a timing diagram showing cryptographic processing of the cryptographic processing circuit 100 according to the first embodiment of the present invention. Symbols shown in the timing diagram of FIG. 2 are defined as follows.
[CLK]: a clock signal
[Key]: a secret key
[D_in]: input data (plaintext)
[Ki]: a round key generated in the round key generating unit 123
[Start]: a cryptographic processing start signal
[Sel]: a selection control signal generated in the selection control unit 111
[Reg_1]: data stored in the register 117
[Reg_2]: data stored in the register 118
[F_in]: input data of the round processing unit 122
[F_out]: output data of the round processing unit 122
[Fin_Flag]: a cryptographic processing end signal
[Reg_o]: output data (ciphertext)

First, the start signal Start (not shown in FIG. 1) becomes high level. In response to this, the selector 113 selects input data D0. The data division unit 114 divides the input data DO into partial data D0_R and partial data D0_L. Assume herein that the partial data D0_R corresponds to upper bits and the partial data D0_L corresponds to lower bits. The data division unit 114 outputs the partial data D0_R to the input terminal “0” of the selector 115 and the input terminal “1” of the selector 116. The data division unit 114 outputs the partial data D0_L to the input terminal “1” of the selector 115 and the input terminal “0” of the selector 116.

At this time, the selection control signal Sel is at high level. Accordingly, the selector 115 selects the input terminal “1” based on the selection control signal Sel at a rising edge of the clock signal CLK, and stores the partial data D0_L into the register 117. The selector 116 selects the input terminal “1” based on the selection control signal Sel, and stores the partial data D0_R into the register 118.

Next, the selection control signal Sel is inverted and becomes low level. In response to this, the selector 119 selects the input terminal “1” based on the selection control signal Sel, and outputs the partial data D0_R stored in the register 118 to the data combining unit 121. The selector 120 selects the input terminal “1” based on the selection control signal Sel, and outputs the partial data D0_L stored in the register 117 to the data combining unit 121.

The data combining unit 121 combines the partial data D0_R received as the upper bits from the selector 119 with the partial data D0_L received as the lower bits from the selector 120. In this case, the combined data serves as the input data DO, which is identical with the data input to the data division unit 114. That is, the input data is reconstructed.

After that, the round processing unit 122 performs round processing on the input data D0 reconstructed by the data combining unit 121, and outputs output data D1.

The selector 113 selects the output data D1 and outputs the selected data to the data division unit 114. The data division unit 114 divides the data D1 into partial data D1_R and partial data D1_L. Assume herein that the partial data D1_R corresponds to upper bits and the partial data D1_L corresponds to lower bits. The data division unit 114 outputs the partial data D1_R to the input terminal “0” of the selector 115 and the input terminal “1” of the selector 116. The data division unit 114 outputs the partial data D1 L to the input terminal “1” of the selector 115 and the input terminal “0” of the selector 116.

At this time, the selection control signal Sel is at low level. Accordingly, the selector 115 selects the input terminal “0” based on the selection control signal Sel at a rising edge of the clock signal CLK, and stores the partial data D1_R into the register 117. The selector 116 selects the input terminal “0” based on the selection control signal Sel, and stores the partial data D1_L into the register 118.

Thereafter, the round processing is repeated by a prescribed number of times (n times) while inverting the selection control signal Sel. After that, the end signal End becomes high level. Output data Dn of the round processing unit 122 is stored into the register 124 at a rising edge of the clock signal CLK, and the output data Dn is output as ciphertext (decryption).

Thus, in the cryptographic processing circuit 100 according to the first embodiment of the present invention, data located at the same bit position is prevented from being continuously stored in the same bit position in the register that stores the round processing results. This makes it difficult for an attacker to estimate a bit change in the register and to carry out a DPA attack or the like as in Japanese Unexamined Patent Application Publication No. 2007-195132. Moreover, the first embodiment of the present invention has a circuit configuration for dividing and selecting the data input to the register that stores the round processing results, and for selecting and combining the output data from the register. This eliminates the need to prepare a plurality of round processing units 122 round key generating units 123. It is only necessary that the registers have a capacity sufficient for holding the input data. Consequently, an increase in circuit size can be suppressed as compared to Japanese Unexamined Patent Application Publication No. 2007-195132.

In view of the above, the first embodiment of the present invention makes it possible to take countermeasures against an attack based on a differential power analysis or an analysis of electromagnetic waves or the like using side-channel information, and to suppress an increase in circuit size.

Although the cryptographic processing has been described as the operation of the cryptographic processing circuit 100 according to the first embodiment of the present invention, decryption processing may also be carried out.

In the cryptographic processing circuit 100 according to the first embodiment of the present invention, the data division unit 114 may have the functions of the selectors 115 and 116. In other words, the data division unit 114 selects the storage destination from among the plurality of data holding units based on the selection control signal. In this case, one output of the data division unit 114 is directly connected to the register 117, and the other output of the data division unit 114 is directly connected to the register 118. The selection control unit 111 outputs the selection control signal to the data division unit 114.

Similarly, in the cryptographic processing circuit 100 according to the first embodiment of the present invention, the data combining unit 121 may have the functions of the selectors 119 and 120. In other words, the data combining unit 121 combines a plurality of partial data items into cryptographic processing target data based on the selection control signal. In this case, the data combining unit 121 is directly connected to the outputs of the registers 117 and 118. The selection control unit 111 outputs the selection control signal to the data combining unit 121.

The selection control unit 111 may output a division control signal for controlling a method for dividing the data input to the data division unit 114 to each of the data division unit 114 and the data combining unit 121. At this time, the data division unit 114 divides the data subjected to cryptographic processing into a plurality of partial data items based on the division control signal, and the data combining unit 121 combines the partial data items into the cryptographic processing target data based on the division control signal. That is, the division control signal may be used to control the division method, such as a method for dividing the input data into upper bits and lower bits, a method for dividing the input data into odd-numbered bits and even-numbered bits, or a method for dividing the input data into randomly selected bits.

### Second Embodiment

The cryptographic processing circuit 100 according to the first embodiment of the present invention has a loop configuration in which the round processing is repeated y a prescribed number of times in the same circuit. Meanwhile, a cryptographic processing circuit 101 according to a second embodiment of the present invention has a pipeline configuration in which two or more circuits are connected to each other.

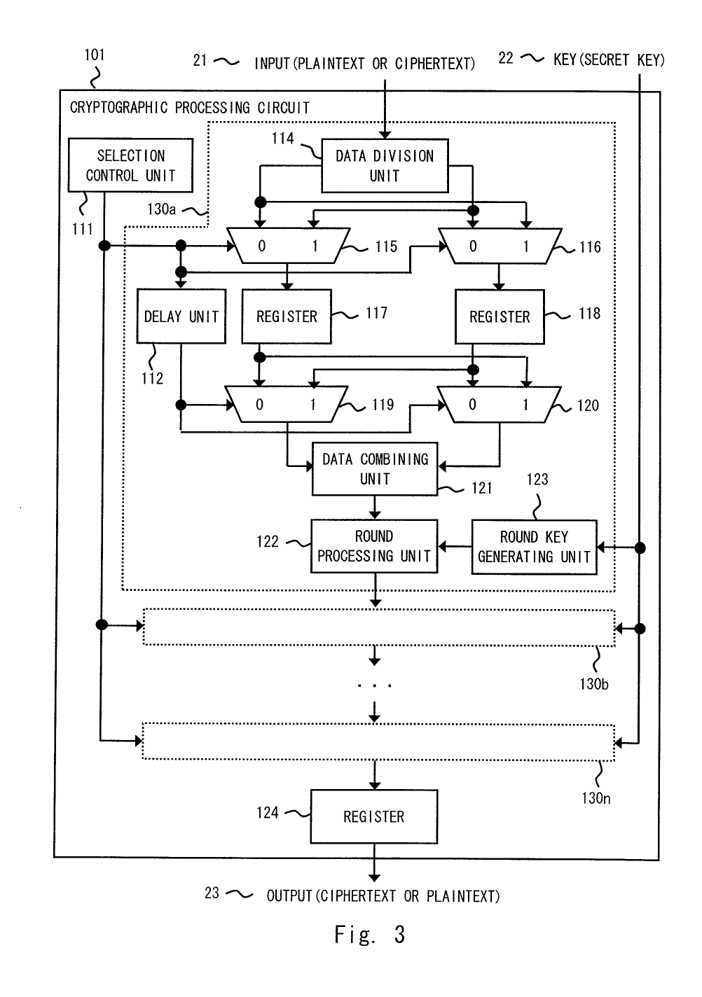

FIG. 3 is a block diagram showing a configuration of the cryptographic processing circuit 101 according to the second embodiment of the present invention. In FIG. 3, components identical with those of FIG. 1 are denoted by the same reference numerals, and the description thereof is omitted.

The cryptographic processing circuit 101 includes the selection control unit 111, round processing circuits 130a, 130b, . . . and 130n, and the register 124. The cryptographic processing circuit 101 is a semiconductor integrated circuit that receives the input data 21 and the secret key 22, performs cryptographic processings in series by the round processing circuits 130a, 130b, . . . and 130b, and outputs cryptographic processing results as the output data 23. When the input data 21 is plaintext, the output data 23 is ciphertext. When the input data 21 is ciphertext, the output data 23 is plaintext.

The selection control unit 111 outputs the selection control signal to each of the round processing circuits 130a, 130b, . . . and 130n.

The round processing circuit 130a includes the delay unit 112, the data division unit 114, the selectors 115 and 116, the registers 117 and 118, the selectors 119 and 120, the data combining unit 121, the round processing unit 122, and the round key generating unit 123, which are shown in FIG. 1. The round processing circuit 130a receives the input data 21 and the secret key 22, and outputs the cryptographic processing results to the round processing circuit 130b.

The round processing circuit 130b receives the output from the round processing circuit 130a and the secret key 22, and outputs the cryptographic processing results to a round processing circuit 130c (not shown). After that, the round processing circuit 130n receives the output from a round processing circuit 130n-1 (not shown) and the secret key 22, and outputs the cryptographic processing results to the register 124. The internal configuration of each of the round processing circuits 130b to 130n is similar to that of the round processing circuit 130a, so the illustration and description thereof is omitted.

Each of the round processing circuits 130a to 130n may not include the round key generating unit 123. For example, the cryptographic processing circuit 101 may include one round key generating unit. In this case, the round key generating unit may generate a plurality of different round keys and output the generated round keys to the round processing circuits 130a to 130n, respectively. Alternatively, the cryptographic processing circuit 101 may not include the round key generating unit. In this case, a plurality of different round keys may be generated outside the cryptographic processing circuit 101, and the generated round keys may be externally input to the round processing circuits 130a to 130n, respectively.

Thus, the round processing circuits 130a to 130n are individually mounted as hardware, thereby enabling high speed cryptographic processing, compared to the first embodiment of the present invention. Also in this case, an increase in circuit size can be suppressed as compared with the case where the cryptographic processing circuit 300 disclosed in Japanese Unexamined Patent Application Publication No. 2007-195132 is implemented as a pipeline configuration.

### Other Embodiment

The registers 117 and 118 included in the cryptographic processing circuit 100 according to the first embodiment of the present invention may be replaced with a group of three or more registers. In this case, the cryptographic processing circuit 100 may include a number of pre-stage selectors and subsequent-stage selectors corresponding to the number of registers. For example, the data division unit 114 divides the input data into a number of partial data items corresponding to the number of registers, and outputs any one of the partial data items to an input terminal of each register. The selection control unit 111 outputs the selection control signal to each register. In this case, the partial data items to be input to each register may be arbitrarily combined. Similarly, the data combining unit 121 receives and combines a number of partial data items from the selectors corresponding to the number of registers.

The present invention can also be expressed in various ways as follows. That is, a semiconductor integrated circuit incorporating symmetric-key cryptography according to the present invention includes: a division unit that divides input data into two or more data items; data holding registers that hold the data items obtained through division by the division unit; a selector that selects an input and an output of the data holding register; and a combining unit that combines the divided data items. This makes it impossible for an attacker to discriminate two or more divided data items held in any of the data holding registers, thereby making it difficult for the attacker to estimate a bit change in each data holding register. Consequently, it is possible to prevent the attacker from carrying out a DPA attack, as in Japanese Unexamined Patent Application Publication No. 2007-195132. Furthermore, it is only necessary that the data holding registers have a capacity sufficient for holding the input data. Therefore, an increase in circuit size can be suppressed as compared to Japanese Unexamined Patent Application Publication No. 2007-195132.

The present invention relates to a semiconductor integrated circuit, and more particularly, to a cryptographic processing circuit that improves resistance to a differential power analysis using side-channel information leaked during cryptographic processing in symmetric-key cryptography implemented as hardware.

The present invention also relates to a technical field of cryptographic processing apparatus in order to solve the problem inherent in Japanese Unexamined Patent Application Publication No. 2007-195132 in that the transition of intermediate data processed in the symmetric-key cryptography implemented as hardware is vulnerable to attacks based on a differential power analysis or an electromagnetic wave analysis, which are examples of side-channel attacks. In the cryptographic processing apparatus, data holding registers and regular data are divided and the data holding registers for storing the divided data are changed by a selection control circuit every time the cryptographic processing is carried out, thereby making it difficult for an attacker to estimate data transition in each register.

Moreover, the present invention is not limited to the above embodiments, but can be modified in various manners without departing from the scope of the present invention.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first and second embodiments can be combined as desirable by one of ordinary skill in the art.

What is claimed is:

1. A cryptographic processing apparatus comprising:
a division unit that divides input data into a plurality of partial data items, the input data being one of plaintext and a round processing result;
a plurality of data holding units that hold the partial data items, respectively; and
a combining unit that combines the partial data items held in the plurality of data holding units into a single round processing target data item to be subjected to round processing, wherein
the division unit selects a storage destination of each of the partial data items from among the plurality of data holding units, and stores each of the partial data items into the storage destination selected, and
the combining unit combines the partial data items into the round processing target item to reconstruct the input data according to the storage destination of each partial data item selected by the division unit.

2. The cryptographic processing apparatus according to claim 1, further comprising a selection control unit that outputs a selection control signal for controlling selection of the storage destination in accordance with a predetermined standard to each of the division unit and the combining unit, wherein
the division unit selects the storage destination from among the plurality of data holding units based on the selection control signal, and
the combining unit combines the partial data items into the round processing target data item based on the selection control signal.

3. The cryptographic processing apparatus according to claim 2, wherein the selection control unit outputs the selection control signal every time the input data is input to the division unit.

4. The cryptographic processing apparatus according to claim 1, wherein
the division unit uses a result of the round processing on the round processing target data item as the input data, and
the selection control unit outputs the selection control signal along with recursive execution of the round processing.

5. The cryptographic processing apparatus according to claim 1, wherein
the selection control unit outputs a division control signal for controlling a method for dividing the input data to each of the division unit and the combining unit,
the division unit divides the input data into a plurality of partial data items based on the division control signal, and
the combining unit combines the partial data items into the round processing target data item based on the division control signal.

6. A control method for a cryptographic processing circuit including a plurality of data holding units, the control method comprising:
dividing input data into a plurality of partial data items, the input data being one of plaintext and a round processing result;
selecting a storage destination of each of the partial data items from among the plurality of data holding units;
storing each of the partial data items into the storage destination selected; and
combining the partial data items held in the plurality of data holding units into a single round processing target data item to reconstruct the input data according to the storage destination of each partial data item selected.

7. The control method according to claim 6, wherein
the storage destination is selected from among the plurality of data holding units based on a selection control signal output for controlling selection of the storage destination in accordance with a predetermined standard, and
the partial data items are combined into the round processing target data item based on the selection control signal.

8. The control method according to claim 7, wherein the selection control signal is output every time the input data is input.

9. The control method according to claim 6, wherein
a result of the round processing on the round processing target data item is used as the input data, and
the selection control signal is output along with recursive execution of the round processing.

10. The control method according to claim 6, wherein
the input data is divided into a plurality of partial data items based on a division control signal output for controlling a method for dividing the input data, and
the partial data items are combined into the round processing target data item based on the division control signal.
